(19) United States
(12) Patent Application Publication
(10) Pub. No.: US 2008/0227053 A1
(43) Pub. Date: Sep. 18, 2008

(54) Device for Preparing and Filling a Tooth Endodontic Cavity

(75) Inventor: Emmanuel Payen De La Caranderie, Colombes (FR)

Correspondence Address: EGBERT LAW OFFICES, 412 MAIN STREET, 7TH FLOOR, HOUSTON, TX, 77002, US

(73) Assignee: MICRO MEGA INTERNATIONAL MANUFACTURES, Besançon (FR)

(21) Appl. No.: 12/091,046

(22) PCT Filed: Oct. 27, 2006
(86) PCT No.: PCT/FR2006/002419

§ 371 Date: May 26, 2008

(30) Foreign Application Priority Data
Oct. 28, 2005 (FR) 0511031

(51) Int. Cl. A61C 5/02

(52) U.S. Cl. 433/102

(57) ABSTRACT

A catheterization device for preparing and filling a tooth endodontic cavity includes at least one root canal tool connected to a drive head. The tool is movable and has a base movably driven by the drive head about the reference axis of the base. A totally or partially eroded, filiform and elastic working part freely extends from the base and has an axis shifted in a parallel position with respect to the reference axis of the base.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a device for preparing and filling the endodontic cavity of a tooth, comprising at least one root canal instrument that can be connected to a drive head.

2. Description of Related Art Including Information Disclosed Under 37 CFR 1.97 and 37 CFR 1.98

The innovation lies in different clinical cases which lead to the opening, exploration and treatment of this space which contained the embryological constituent residue of the tooth: the nerve. Called devitalization, this maneuver assumes a more pronounced surgical aspect when it involves necrosis, this then being referred to as cleaning of the wound. This work, and the filling of the space created at the expense of the tooth is called endodontics.

The present invention is aimed at allowing this treatment to be performed with greater efficacy and ease and with less instrumentation. The current prior art has been identified and its limits have been overcome.

The present invention thus relates to a device for treating the entirety of the endodontic cavity of a tooth, comprising at least one eroding root canal instrument that can be connected to a drive head moved by any known means.

The shortcomings of the prior art in the field of endodontics will now be discussed, these shortcomings having led to the development of the invention.

The lack of reliability of previous or recent treatments, and the stress and fatigue accompanying this demanding treatment, show the need to increase the percentage of success and to improve the conditions of this success.

Removing the pulp is an incomplete procedure for achieving success in this treatment. It requires widening of the canal, which the innovation achieves successfully. “Shaping” a root canal nowadays represents the result of the action of the presently known instruments. Mechanical reaming with instruments of circular cross section at the expense of a cavity of any given shape, which is therefore only partially instrumented, or rendered fragile, can present a relative displacement of canal or apex. The instruments of eccentric cross section induce a tightening sensation and do not free the sensibility of the maneuver by the practitioner. Their use causes a relative displacement of the canal, which it is difficult to control. Finally, the instruments for partial shaping, in particular those proposed by patent No. FR 2 735 012 A, which impose a volume of revolution on a canal portion, create abutments at their end. Even longer, they produce a mobilization of the tooth organ, very uncomfortable for the patient, and sometimes, when the axis of rotation moves away from the axis of the canal to be treated, they cause jolts and knocks. Their necessary rigidity for purposes of efficacy is contrary to simple homothetic widening or reaming conserving the solidity of the tooth organ, which is advantageously achieved by the present innovation, in contrast to the other known devices. At the same time, they also do not permit total ablation of the tissues present in the cavity.

Several phases overlie and overlap one another in the known protocols: opening of the pulp chamber or of the canal, this being the access cavity; catheterizing the canal or canals; marking out the length and shape of the main canal of the root, extirpating the contents, dressing the endodontic walls, irrigating using an antiseptic solution, actual shaping of the canal by reaming, using partial or whole-length reamers, and increasing diameters by either manual or continuous rotation of the upper part of the canal, more rarely for the apical part. Finally, filling after drying, is last before three-dimensional sealing of the prepared cavity.

The object of the present invention is to reduce the number of these steps and also the number of instruments needed to carry them out. By contrast, all existing devices which, included in a multi-instrument protocol, carry out only part of the operation to be performed, spatially (especially patent FR 2 735 012 A, for the operated zone), (and U.S. Pat. No. 4,992,048 for the movement described), and in the protocol (same patents).

To this end, it relates to a “Device for preparing and filling the entirety of the endodontic cavity of a tooth”, in contrast to patent FR 2 735 012 A which treats only the coronal ⅔ of the canal, “comprising at least one root canal instrument (1) connected to a drive head (10) which is moved by any known means. The root canal instrument (1) is composed of a base (2) that can be driven in a movement”. In contrast, the instrument part shown in U.S. Pat. No. 4,992,048, “by a drive head (10) about a reference axis (A), from which base (2) there freely extends a filiform, elastically deformable and flexible working part (3) whose axis is offset in parallel with respect to the main reference axis (A) but is centered about the latter in order to generate any theoretical volume of revolution (VI), advantageously cylindrical”, in contrast to patent FR 2 735 012 which delivers a conical movement, “when it turns without constraint, and to adapt itself to a cavity of any volume (V2)”, in contrast to the device protected by patent No. FR 2 735 012 A which imposes its form of rotation, “to be worked when it is constrained by the latter, this being of narrower cross section than the theoretical volume of revolution (VI) of the instrument (1), and in that furthermore the free end of said flexible working part is maintained spatially on a bearing zone (P), which can be the apical cover zone, situated at the bottom of the cavity to be worked, in such a way as to obtain a multi-function instrument capable of performing all of the following: catheterization, apical and coronal reaming, and surgical aspiration of the grinding residues and their ejection toward the canal outlet by simple angular displacement of the axis of rotation of the base of the instrument, in one direction or another, by virtue of the mechanical qualities, with respect to the bearing zone P.” These multiple functions distinguish the present innovation from the two aforementioned patents and from the known prior art.

### BRIEF SUMMARY OF THE INVENTION

The invention thus proposes creating a virtual volume by the axis of the working part off-centered with respect to the axis of rotation of the guide or by the guide itself off-centered with respect to the axis of the rotor. Since the root canal instrument can be composed of a base whose axis corresponds to the axis of rotation of the drive head, it is the filiform part that is off-centered, but the root canal instrument can also be composed of a base whose axis of rotation is off-centered from the axis of rotation of the drive head, these means responding to our initial description.

Thus, a simple solution is created for pulpectomy and erosion of the canal surface using the mechanical act of cutting. This phase is therefore done by an instrument that describes a volume of revolution. The instrument describes a trajectory that uses the surface of the virtual volume, and its elasticity forces any constraint encountered in its path toward the initial volume of revolution. The dynamic of the movement creates a resiliency of shape by restitution of the virtual volume by virtue of the elasticity of the material of the instrument. This permits work made possible by surface reliefs of the instrument, which has a tangential cutting function. Several possible offcenters can be provided both in terms of the design of a canal instrumentation and of an instrument head. Thus, the practitioner is able to choose or adapt an instrument depending on the clinical case in question.

Smooth zones or zones with no working relief avoid the opposition of two zones or points of blocking, reducing the risk of fractures. They are arranged diametrically opposed and/or arranged in longitudinal areas making it possible to work in a sectorial manner on double curves, for example.

A succession of markings make it possible, in a first stage, to determine the working length. Then, in a second stage, to comply with this during working, the latter is done only in a movement essentially of revolution. This in a permanently controlled plane, since the movement is not longitudinal. This control is necessary to adjust for differences of the working instruments (especially patent FR 2 735 012) on a certain portion of the canal which do not have the indispensable use of these markings.

A weak point forms a preferential fracture zone at a distance from the root canal zones, and gripping the fractured segment is thus made easier. It will be noted that a catheterization instrument is less strongly sheathed than a shaping instrument and therefore easier to extract.

By virtue of this movement of exploration of the canal surface, the working part of the instrument carrying a cement or a liquid or pasty product for coating the whole surface of the canal for the purpose of coating its walls and/or for filling it.

Such a device makes it possible to eliminate the difficulties and shortcomings of the prior art by providing solutions thereto.

CONCERNING ACCESSIBILITY:

This is one of the most obvious indications for use of a contra-angle instrument holder, which permits a secure hold with a strong angulation of the instrument in order to access this channel. There only remain the precision in the marking and intromission in the inlet of the canal. It is here that the absence of repetition of this maneuver has all its necessity. Once the canal is found and the instrument positioned, it would be advantageous if the instrument is no longer withdrawn, which is what the novel device proposes in contrast to the instruments included in a protocol or performing only part of the work on the canal (aforementioned in the patents studied by the WIPO examiner and classed A). Even a catheterization performed once by an instrument with a diameter of 10/100th makes it possible to know the dimension and direction of the canal. Thus, repeating this maneuver once it has been performed manually by an instrument of the same dimension is relatively easy if the return is effected only once. This difficulty existing, even if the repetition of the complex maneuver is what the concept seeks to eliminate.

CONCERNING VISIBILITY:

It is when locating the canal inlets that its difficulties are stigmatized, hence reducing the repetitions of this maneuver will greatly facilitate the speed of execution of the therapeutic procedure, and the accumulated fatigue will be less great. The placement of external markings is possibly justified in future.

CONCERNING THE MANEUVER:

Increasing use of mechanization is a response to the physical fatigue of the practitioner, but it is by contrast necessary to leave open the possibility of using fingers. Although this novel device permits both, it does not permit easy use of the fingers to widen the canal, since the mechanization has the advantage. This also requires ergonomic study of the mandrel whose grip has to be optimized.

CONCERNING THE ADVANTAGES OF REDUCING THE LONGITUDINAL MOVEMENTS:

The reciprocating type of movement necessitates permanent control of the length of the instrument. This type of movement pushes septic debris past the apex, like the partial instruments, and extirpation of the contents of the canal necessitates frequent reciprocating movements that produce plugs of pulp tissue or dentine tissue. It will be noted that a rotary instrument partially engaged in the canal, as is proposed by patent No. FR A 2 735 012, produces a possible accumulation of debris below its end. Thus, the permanent permeability afforded by placement of a thin instrument avoids all of these problems. The absence of repeated reciprocating movements limits the trauma around the apex, and the size of this zone in a certain manner.

The instrument stresses under torsion cause breaks, the movement only causes few or no blockages, moreover the smooth zones limit the blockages in opposition.

CONCERNING ADVANTAGES OF A FREED MOVEMENT:

The absence of tightening stresses frees the tactile sensibility of the practitioner, this brings back to the fore dexterity and experience. This does not in any way complicate training: the controls being the same as those in preparing the peripheral crown according to the three axes (Joint prosthesis: bridge and crown). However, a highly eccentric or quite strongly oblique origin of the working part provokes a return stress in the hand of the practitioner, in contrast to an offcentering produced by an elastically deformable instrument which does not in the first instance impose its volume of revolution. The invention proposes reaming the canal, by simple widening, in an essential movement of exploration of the walls by the instrument, the result being that the stresses opposing the movement are more limited, since they are in only a single direction. The hand is progressively freed from the cover formed by the canal.

CONCERNING THE WORKING LENGTH:

One of the main steps of the endodontic protocol is its determination. For some practitioners, apex locators have facilitated their task. Radio, instrument in place giving greatest reliability. For others, the tactile feel is their best option. The invention does not prevent any of these methods. Moreover, the instrument succession is a source of errors, since the stops are not always well fixed or well regulated. When this length has been determined once and for all, the instrument in place and not producing reciprocating movements has no need to be directly controlled if the movement is only in a plane transverse with respect to the general axis of the tooth. Carries color markings on the part adjoining the handle, according to another feature of the invention, or on a remote accessory.

These advantages definitively distance the known prior art, which is inscribed in protocols by steps, where the devices work on a part of the length of the canal.

CONCERNING THE SHAPE OF THE INSTRUMENTS:

The instruments of round cross section produce a cylindro-conical canal shape, which can cause weakening when certain walls or even the floor of the root are over-reamed, since they impose a reaming shape systematically producing a relative displacement of the canal. The instruments which impose a volume of revolution without being elastically deformable impose the same shape. The invention seems to respect the initial anatomy when it is used according to the proposed rules, but, by displacing the pressure on a wall, certainly permits a rectification of the trajectory for purposes of accessibility. The production of sectorial working or eroding surfaces makes it possible, in the most difficult cases, to erase accentuated curves without forming stops or loss of canal lumen through packing, which seems to be the case with partial instrumentation of the canal (patent FR 2 735 012 A). According to one of the other features of the innovation. A choice of instruments will be proposed, in all cases the end does not have to be sharp or be working in these precise cases, since on only part of the canal this type of rotation movement with a radius greater than the initial radius of the canal the end of the instrument will produce a notch, making subsequent permeablilization very difficult (patent FR 2 735 012 A). The same applies to the instruments delivering a sound wave or ultrasound wave (U.S. Pat. No. 4,992,048). According to the innovation, there is no doubt that an apparent displacement of the canal is produced, but it remains very small.

Irrespective of the cross section of the known instruments and their movements, they can weaken certain walls of the root, or even the floor. In all cases, they impose a reaming shape without any choice by the practitioner, systematically producing a relative displacement of the canal, and imposed on the initial anatomy. The round cross-sectional shape that turns about itself “forgets” the diverticula that are seen in the cross sections of a large number of canals. Thus, numerous zones are not accessed by the instrument. An exploration movement, such as is proposed, with an elastically deformable working part, reaches all the walls, whatever their position or their shape. The present innovation uses the walls equivalently when the axis of rotation is kept coaxial with the axis of the canal: mechanically and geometrically evident. This assertion is confirmed by the tests: 100% of the walls are accessed by the instrument. This obvious advantage will be immediately seen on a straight canal or one with a slight curvature.

When the curvature is more accentuated, the pliability of the metal used permits working on each of the walls, indeed in a first stage the instrument of diameter close to that of the canal (since it is a catheterization instrument) sheathed by these works practically in rotation on itself, hence in a quasi equivalent manner on the upper walls and lower walls thereof. The invention advantageously performs this work on the walls in a quasi equivalent manner.

It seems preferable to choose a surface whose roughness is effective in the transverse direction with respect to the axis of the canal, and not in the longitudinal direction, which makes catheterization easier and makes the grinding effective when the instrument is mounted on the rotary head.

CONCERNING THE NUMBER OF INSTRUMENTS:

There are on average six to eight instruments per canal, with all the handling that this entails. The ideal is of course to limit the instrumentation both for the apical and coronal reaming, the invention proposing only one of these; but can easily be attached to any procedure. This in contrast to all the instruments known in the prior art.

CONCERNING THE NUMBER OF STEPS IN THE PROCEDURE:

Reducing the number of steps is achieved by reducing the number of instruments, the dressing of the canal by irrigation could be done by rotation of the liquid originating from the spray. The vortex demonstrated in the physical explanation permits ascent of the debris charged with antiseptic. This movement would be assisted by use of surgical aspiration opposite the access cavity, via a standard or straight aspiration cannula installed along the instrumentation. This reduction in the number of steps of the procedures is in opposition to the prior art documents identified. Moreover, a simplified protocol favors its learning.

CONCERNING THE NUMBER OF STEPS OF DISINFECTION OF THE INSTRUMENTS:

Fewer instruments mean fewer manipulations for decontamination and sterilization of the material. This reduction in cost would allow the launch of a disposable instrument on the market. Greater safety is thus achieved at a reduced cost.

CONCERNING THE DRESSING OF THE CANAL:

Dressing a wound signifies excision of damaged tissues, its disinfection by this removal and by application of an antiseptic solution. The use of a spray charged with sodium hypochlorite could permit this, provided that the projection of the spray is controlled. Other antiseptic solutions permitting use in the form of a spray are in the course of being studied on the flora found in root canals. However, the use of the device according to the invention does not prevent the use of known techniques or instruments. This further increases the quality of the work on the entire surface, contrary to the instruments which have a sectorial activity.

CONCERNING THE PROBLEM OF STORING THE INSTRUMENTS:

Responding to this problem is possible through a less costly procedure in terms of instruments, and the novel device presented responds to it. The one-off use is all the more relevant since the manipulations are fewer in number, and therefore less costly, both in terms of labor and in space and time requirements.

CONCERNING THE EASE AND QUALITY OF FILLING:

The sealing of a filled canal is better when the canal is dry and emptied of its contents. The efficacy of the concept seems to be greatly superior to all the currently existing techniques, and in fact no diverticulum remains after passage of the innovation. Moreover, the grinding of the walls under irrigation would appear to open the accessory canals with greater efficacy: three-dimensional sealing of the endodontic space would be possible with greater reliability by virtue of this preparation of the canal. The use of the innovation for coating the wall and easy according to another feature of the innovation.

In conclusion:

The innovation is represented by a device which forms a volume of revolution. The surface described is the axial face of a volume generated by a curve, called the directrix, turning about a fixed straight line, called the axis of revolution.

In fact, it describes a surface which is closed on itself and which is one of the axial faces of the volume or its complete surface when there is closure or reduction of the lower surface. The general direction is the same on a new instrument. The volume is determined perfectly by this direction, and by the radius or radii of rotation of the instrument with respect to the axis of rotation and to the instant centers of rotation, if this movement is elliptic. When the end of the working part is maintained spatially by a point or by a zone of smaller diameter, the movement is different from a cone within the strict sense by the movement of the apical zone, not reduced to a point.

Thus, the introduction of the instrument in a volume of small diameter prior to rotation produces, during the rotation, variable dynamic volumes of revolution: cylindrical, conical, hyperboloid, ellipsoid, paraboloid, catenoid, hence sometimes more or less conical, at least at the start when the apical zone is more or less punctiform. Its self-adaptability thus produces, via the successive stresses and releases, other dynamic volumes which succeed on another and gradually restore the volume of revolution of the instrument not subjected to a stress, or proposed by the instrument head. The effect on the walls of the canal is related to its surface state, which can then have an effect of reducing its thickness, the instrument will then have a widening effect and on account of the elasticity of the material of the instrument, the diameter of the canal will thus be enlarged. In a complex volume, the walls all appear to be reached by the instrument, which is an advantage and an undeniable advance. As has thus been shown, the invention permits the reaming of dental canals with a complex internal volume.

With a catheterization instrument, or a thin and flexible instrument permitting complete reconnaissance of the canal, this permits reaming or enlargement of the volume of the canal for purposes of pulp removal and/or smoothing of the canal.

Since the present invention advantageously permits extirpation of the content of the canal by its simple movement and the action of the working parts, even if this can be advantageously augmented by an operation comprising surgical aspiration or by surgical aspiration itself positioned near the operating act itself. In fact, in all cases of root canals, the movement obtained, by the stress of the worked shape, produces more or less a truncated cone all along the endodontic space. Along the zone of greater diameter, the instantaneous linear speed of rotation is greatest. In fact, an eroding instrument set in rotation by a motor at a constant speed delivers a constant speed to all the points of the surface of the working instrument. The latter, inserted in a more or less conical volume, will see its movement constrained more by its distal end than by its proximal part. This zone producing a longer path than the other at the same speed therefore goes relatively faster. Attraction of the contents toward the zone of greater diameter is created by the zone of greatest acceleration. A vortex is produced and the naturally established force of aspiration is towards the diameter of greater contour, a small-scale venturi effect, involving a biophysical model of the tornado. Thus, the residues of grinding are entrained toward the canal outlet. This can be seen in the tests carried out: the debris is not propelled to the apical outlet but to the canal outlet.

Thus, the concept and the instrument are perfectly adapted to what is expected of this maneuver: removing of the pulp tissue or necrosed content of the canal and its contiguous dentine part, and cleaning of most or all of the wound created. It is also possible to expect the pulp strands to be torn from the secondary or accessory canals, providing extirpation of a spider-like network of pulp.

The instrument is therefore a catheterization instrument of which all or part of the periphery is working, producing one or more surfaces of erosion by friction. The working reliefs are arranged in a uniform or random manner, the axis of this filiform part being in the same plane as a generatrix of a contra-angle instrument mandrel provided with a dovetail for blocking purposes in the direction of its axis. The blunt end may not comprise abrasives, the instrument being cylindrical or cylindro-conical with a small apical diameter. The mandrel can be covered by a detachable manual sleeve to permit connection of the rotary head, or can have opposite flat areas making it easier to hold without preventing its initial function.

It is therefore also a reaming instrument whose rotation describes off-load, when it is not stressed. A volume of revolution erodes the walls of the canal via its reliefs, its travel, its speed and the elasticity of the material used. On account of the clamping of its end, the movement in a canal produces a volume of revolution whose dynamic tends toward a cylinder. The height of the widest part thus varies and tends toward the working length that corresponds to the length of the part of the instrument within the canal.

### BRIEF DESCRIPTION OF THE SEVERAL VIEWS OF THE DRAWINGS

The invention also relates to the features that will become evident from the following description and that are to be considered in isolation or in any of their possible technical combinations.

This description, given by way of non-limiting example, will permit a better understanding of how the invention can be realized, with reference to the attached drawings.

FIG. 1 shows a schematic view of a root canal instrument according to an illustrative embodiment of the invention.

FIG. 2 shows a schematic view of a volume of revolution of the instrument according to FIG. 1, when it is not constrained.

FIG. 3 shows a schematic view of a volume of revolution of the instrument according to FIG. 1, when it is constrained.

FIG. 4 shows a schematic view of the zone of presence of the instrument when it is constrained by any given volume.

FIG. 5 shows a schematic view of the ratio of work between the top part and the bottom part of the root canal end.

FIG. 6 shows a schematic view of the evaluation of the virtual displacement of the canal on account of the instrument rigidity and the axis of rotation at a distance from the axis of the working part.

FIG. 7 shows a schematic view of the controlled canal displacement.

FIG. 8 shows a schematic view of the variations of the effects of the radius and of the exploitation to the limit of the radius.

FIG. 9 shows a schematic view of the phenomenon of knocking in limit positions.

### DETAILED DESCRIPTION OF THE INVENTION

The root canal device is composed of at least one root canal instrument (1) connected to a drive head (10) which is moved by any known means. The root canal instrument (1) is composed of a base (2) that can be driven by a drive head (10) in a movement about a reference axis (A), from which base (2) there freely extends a filiform and an elastically deformable and flexible working part (3). The axis of the working part (3) is offset in parallel with respect to the main reference axis (A) but is centered about the latter in order to generate any theoretical volume of revolution (VI). Being advantageously cylindrical, it turns without constraint and adapts itself to a cavity of any volume (V2) to be worked when it is constrained by the latter, this being of narrower cross section than the theoretical volume of revolution (V1) of the instrument (1). Furthermore, the free end of said flexible working part is maintained spatially on a bearing zone (P), which can be the apical cover zone, situated at the bottom of the cavity to be worked. In this way, a multi-function instrument capable of performing all of the following is obtained: catheterization, apical and coronal reaming, and surgical aspiration of the grinding residues and their ejection toward the canal outlet by simple angular displacement of the axis of rotation of the base of the instrument, in one direction or another, by virtue of the mechanical qualities, with respect to the bearing zone P.

According to a first application example, the root canal instrument 1 is composed of a base 2 whose axis corresponds to the axis of rotation of the drive head 10, which is also the reference axis A. The axis B of the working part 3 is offset in parallel with respect to said reference axis A and, consequently, with respect to the axis of the base 2.

According to a second application example, the root canal instrument 1 is composed of a base 2 whose axis is concentric to the axis B of the working part 3. The axis of rotation of the drive head 10 corresponds to the reference axis A, being offset in parallel with respect to said axis B of the base 2 and 5 of the working part 3 which is concentric to it.

According to another feature of the innovation, the working part can advantageously have its off-centering increased or reduced with respect to the base or with respect to the axis of the drive head.

According to another feature of the innovation, the working part can have smooth zones reducing the oppositions of blocking zones or points, reducing the risk of fractures.

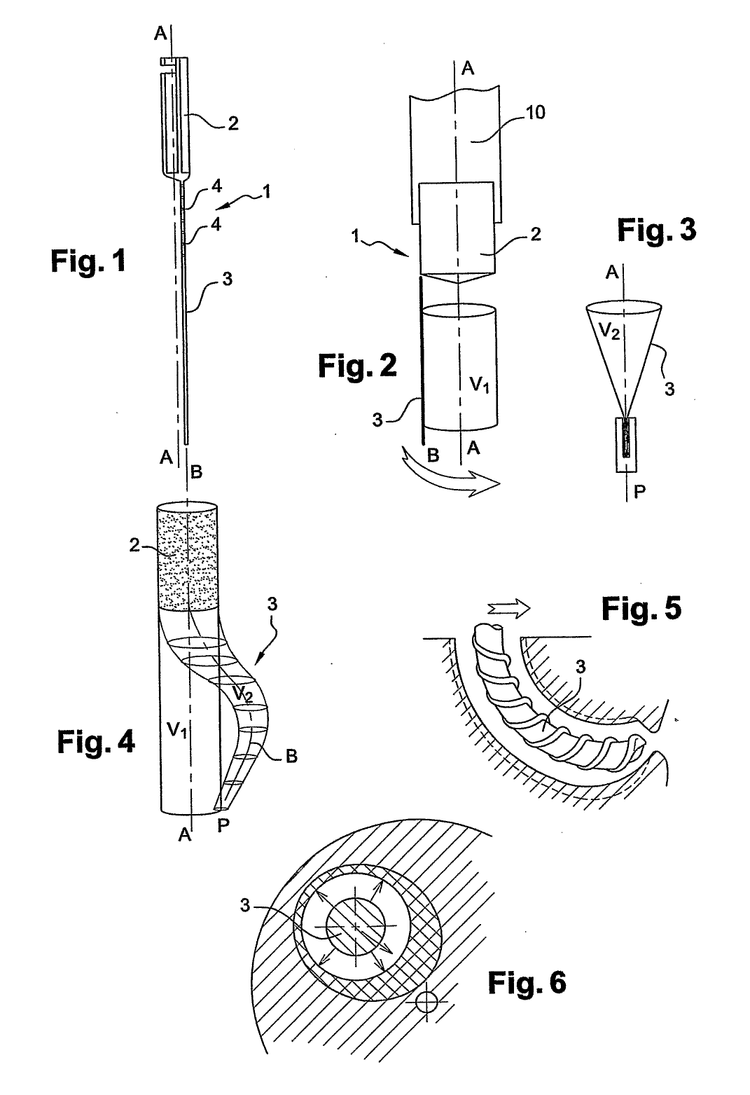

According to another feature of the invention shown in FIG. 1, the instrument 1 has a succession of markings 4 which are colored or uncolored and which make it possible, in a first stage, to determine the working length, and then, in a second stage, to comply with this during the working, the latter being done only in a movement essentially of revolution.

According to another feature of the invention, the working part 3 of the instrument 1 has a weak point which forms a preferential fracture zone at a distance from the root canal zones. In the event of breaking, simple gripping of the part disconnected from the drive head 10 or the shank of the root canal instrument is permitted.

According to another feature of the invention, the working part 3 of the instrument 1 carries a cement or a liquid or pasty product for coating all or part of the surface of the canal for the purpose of coating its walls and/or filling it.

With such an instrument 1 according to the invention, the instantaneous linear speed of rotation is greatest along the zone of greater diameter: indeed, a cylindrical or cylindro-conical grinding instrument, set in motion, delivers a constant speed to all the points of the surface of the working instrument.

In a straight canal, the virtual cylindrical volume of revolution, the outer surface of which is formed by the trajectory of the instrument, is constrained to a cone-shaped volume. The elasticity easily allows this efficacity to be imagined, which makes it possible to obtain substantial widening of the canal in the area of the inlet in a few seconds.

As is shown in FIG. 5, in a curved canal, the end of the upper part of the canal would, because of the instrument rigidity, not be accessed by the instrument or only partly accessed.

However, whether in the coronal part or also in the apical parts, the instrument will retain all its efficacy, because the catheterization instrument is very close to the canal walls.

This means that the instrument efficacy will be tangential. As the instrument is designed for this purpose, a maximum of efficacy is thus possible on all the walls. Moreover, the fineness of the instrument means that it is unlikely that the rigidity will “get the better of” the cover. Thus is also introduced the problem of displacement of the canal, which can be harmful or useful and even makes it possible to sense the end of the treatment.

On account of the substantial efficacy of the instrument, it is probable that inappropriate use could displace the canal, even the apex.

FIGS. 5 and 6 explain the geometric and physical reality of the canal displacement. In FIG. 6, the axis of rotation symbolized by a circle, which surrounds the axis of rotation, shows the instrument hatched obliquely downward and to the right, the dentine hatched obliquely downward and to the left. FIG. 5 shows the ratios of proportionality between the instrument and the canal diameter, and the parts of the canal preferably “machined”.

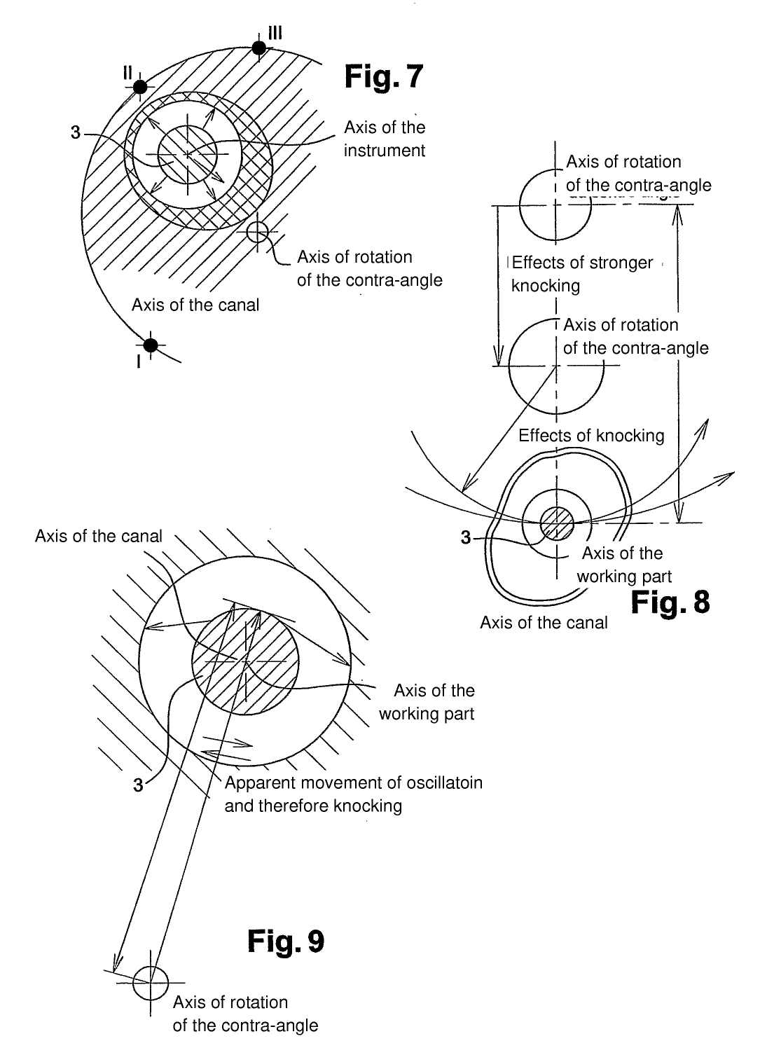

As is clearly shown in FIG. 7, the canal displacement is controlled. At reference sign I, one finds the maximum instrument tension 17 of the elasticity of the material, hence the maximum tangential efficacy, hence the maximum milling efficacy. At reference sign II, there is the minimal efficacy. At reference sign III, there is the mean efficacy. But it is the hand of the practitioner and clinical feel that comes to the fore here. Indeed, the use of the elasticity by controlling the displacement of the axis of rotation of the contra-angle makes it possible to increase the efficacy on the walls, as is shown in the aforementioned FIG. 7. This particular work is done in complete safety since the canal lumen is permanently maintained. Hence, no dentine plugs are to be provided, no loss of canal direction, no abutments and no steps. Here too, one of the advantages of the device according to the invention is the permanent retention of permeability of the canal.

The hand of the practitioner is able to displace the axis of the contra-angle at will. It is a matter of the limits of resistance of the materials, and the limits of comfort. Indeed, one of the important objections is this pendulum effect which causes jolts and knocks. These appear to be important under certain conditions that have been able to be identified. These effects have been explained and responses have been given, based on the fact that the jolts and knocks are the result of the multiplicity of stresses, which vary in intensity and in direction. The resultant of these stresses is also expressed according to axes that vary in space and in time, as also does its bearing point.

It has been chosen to give priority to the tangential stress that cuts the dentine, and in giving priority to this stress, it has been chosen to increase the cutting effect. The greater this efficacy, the more rapid and clean the cut, unless there are problematic effects. It has thus been chosen to optimize the conditions of comfort by the choice of suitable rigidity, of controlled and slight off-centering, by an instrument that is not oblique or barely oblique, and by control of the speed of rotation. Furthermore, an oblique axis prejudices the precision of the working length.

The sign of instrument vacuity felt during the work could be clinically our sign of arrest of movement. This directs the device even more towards the clinical and tactile feel of the practitioner.

1. A device for preparing and filling an entirety of an endodontic cavity of a tooth, comprising:
at least one root canal instrument; and
a drive head, being moveable and connected to the root canal instrument, said root canal instrument being comprised of a base driven by said drive head in a movement about a reference axis, said base having a filiform extending freely therefrom and an elastically deformable and flexible working part, the working part having an axis offset in parallel with respect to said reference axis and centered about said reference axis in order to generate any theoretical volume of revolution, the volume of revolution being cylindrical, said working part turning without constraint and being adapted to a cavity of any volume, said working part being constrained by the volume of said cavity, said volume of said cavity having a narrower cross section than the theoretical volume of revolution, said working part having a free end maintained spatially on a bearing zone, said bearing zone being an apical cover zone, situated at a bottom of said cavity.

2. The device as claimed in claim 1, wherein said working part has a working axis offset in parallel with respect to said reference axis, said working axis being offset with respect to an axis of the base.

3. The device as claimed in claim 1, wherein said working part has a working axis, said base having a base axis, said base axis being concentric to said working axis, said reference axis being offset in parallel with respect to said base axis and said working axis.

4. The device as claimed in claim 1, wherein said working part has adjustable off-centering with respect to said base or said reference axis, or both.

5. The device as claimed in claim 1, wherein said working part has smooth zones reducing the oppositions of blocking zones or points, reducing risk of fractures.

6. The device as claimed in claim 1, wherein the instrument has a succession of markings indicating working length, said working length being indicated during rotational movement.

7. The device as claimed in claim 1, wherein said working part has a preferential fracture zone at a distance from root canal zones, a part disconnected from said drive head or a shank of the root canal instrument being gripped when the root canal instrument breaks.

8. The device as claimed in claim 1, wherein said working part has a coating dispersed on a surface of the canal.
